(19) United States
(12) Patent Application Publication
(10) Pub. No.: US 2007/0294704 A1
(43) Pub. Date: Dec. 20, 2007

(54) BUILD-TIME AND RUN-TIME MAPPING OF THE COMMON INFORMATION MODEL TO THE JAVA MANAGEMENT EXTENSION MODEL

(75) Inventors: Nicholas M. Stephen, Grenoble (FR); Eamonn McManus, Grenoble (FR); Thierry Roussel, Meylan (FR); Arieh Markel, Broomfield, CO (US)

Correspondence Address: HOGAN & HARTSON LLP, ONE TABOR CENTER, SUITE 1500, 1200 SEVENTEEN ST., DENVER, CO, 80202, US

(73) Assignee: SUN MICROSYSTEMS., INC., Santa Clara, CA (US)

(21) Appl. No.: 11/424,540

(22) Filed: Jun. 15, 2006

(51) Int. Cl. G06F 9/46; G06F 9/45

(52) U.S. Cl. 719/315; 717/141

(57) ABSTRACT

A compiler converts managed object format code or common information model extensible markup language code to instances that can be implemented by management extension models such as Java Management Extension MBeans. The instances which are generated by the compiler interface work together with a meta-model service that exposes the semantics of each object within the common information model to the run-time environment through a parallel managed extension model interface. This meta-model also introspects the common information model so as to provide a query service by forming associations between objects of the common information model and instances of the management extension model.

### BACKGROUND OF THE INVENTION

1. Field of the Invention

The present invention relates, in general, to information models in computer architecture, and, more particularly, to software, systems and methods for build-time and run-time mapping of the common information model to other management extension models.

2. Relevant Background

One general architecture and schema for managed objects is known as the Common Information Model (CIM). The Common Information Model (CIM) defines the model used to represent, in a generic form, the real-world objects being managed by a computer system. FIG. 1 shows a generic logical representation of pertinent components and data structures relating to an operating system's management infrastructure as is known in the prior art. The operating system 110 includes a management infrastructure 120 for managing the operating system, applications, and computer hardware. An example of this infrastructure includes the Web Based Enterprise Management (WBEM) administered by the Distributed Management Task Force (DMTF). The management infrastructure 120 provides an object-oriented way of monitoring, configuring and controlling systems, services, and applications. The management infrastructure typically uses classes derived from the CIM. To support the CIM, the management infrastructure 120 maintain a meta-model with schema definitions 130 and permits the registration of management object providers. The meta-model schema 130 contains a definition of each class along with the properties and methods of each class, and the relationship between the classes. The Model 140 contains all the managed object instances responsible for responding to requests on specific instances of classes described in the schema.

CIM uses an object-oriented paradigm, wherein manageable objects are modeled using the concepts of classes and instances. The logical view of CIM is similar to the view of an object-oriented database, in which protocol operations carry out changes to this schema. For example, the Put Class protocol operation is used to create a class definition within the targeted server, while the Get Instance operation retrieves an object from the server that describes a particular instance of some managed object, such as a network device. The components of CIM, such as classes, instances, and qualifiers can be conveniently described in a textual format known as Managed Object Format (MOF).

The meta-schema objects of CIM are components used to model a managed object using CIM. Classes are models or templates for manageable objects, while instances are occurrences of classes, properties are the individual fields of classes or instances, and qualifiers are modifiers of any of these. In CIM, objects are essentially representation objects, i.e., the data object manipulated by a user of CIM is typically a proxy or representation of a real device. Locally, the server binds the representation object to the real-world device through various instrumentation methodologies specific to a particular system.

In general, in a CIM installation, a process acting in the role of a client makes management requests, while a process acting as a server satisfies each requested task and returns an appropriate response via uniformly rendered managed objects. Clients may be simple processes dedicated to the management of particular devices or machines, or, for example, may be general-purpose interactive browsers capable of managing objects. Servers may also be implemented in multiple levels. In high-complexity environments, servers may be running on workstations with complex object stores, and act as proxies for many different managed devices. In lower complexity settings, servers may be simple network devices with no object store, implementing only a subset of a communication protocol. Moreover, the roles of servers and clients may be combined to form hierarchical and/or distributed management. For example, a client can make a request of a server, and that server in turn can switch roles and become a client of yet another server in order to carry out the operation.

In any event, the general architecture of a CIM installation includes management applications in which clients communicate management information requests with a server. It is the server which implements a large subset of the communication protocol, and which switches roles so as to act as a proxy on behalf of client requests. As part of its function, the management application passes the client requests to appropriate servers known as object providers (or simply providers). Providers typically implement a smaller subset of the communication protocol and do not switch roles. By way of example, one type of provider is a software driver or the like, supplied by a vendor to accompany a hardware device such as a disk drive.

By way of another example, the CIM installation may include a Printer object, however, the object is not the actual printer, but a model of a printer. Performing an operation on the Printer object, such as examining its “Status” property, appears as a simple database query to retrieve the value, but the local implementation may in fact invoke systems software in real-time to retrieve the value of the Status property.

MOF files are used to specify schema to the management application via a MOF Compiler (really a MOF Loader). These expressions of the application objects in MOF form are submitted to a MOF Compiler and an instance or representation of the model is generated that can both be discovered and communicated with using the CIM operations. Individual objects within the model can be interrogated and managed in a formal way using the CIM operations, to get and set various properties of the managed object, for example. Since CIM started its life in the traditional device management arena, the concepts necessary to build application-level management are relatively new to it and not well employed.

Java Management Extension (JMX) technology (Java™ is a trademark of Sun Microsystems, Inc.) is an open, JAVA-centric technology for management and monitoring of objects and applications that can be deployed wherever management and monitoring are needed. By design, this standard is suitable for adapting legacy systems, implementing new management and monitoring solutions and plugging into those of the future. A Managed Bean (MBean) is a managed Java object that can represent a device, an application, or any resource that needs to be managed. MBeans expose a management interface or a set of readable and/or writeable attributes and a set of operations that can be invoked, along with a self-description. A standard MBean is composed of the MBean interface which lists the methods for all exposed attributes and operations, and the class which implements this interface and provides the functionality of the resource. An MBean Server is a container in which addressable MBeans are registered.

By analogy and referring to FIG. 1, the MBean Server is represented by the management infrastructure 120 and the Mbeans are represented by the managed object providers 140. JMX does not provide the built-in facilities for managing a schema 130, since each MBean is self-descriptive.

JMX is the standard way to instrument Java 2 Platform, Enterprise Edition (“JAVA EE”) and Java 2 Platform, Standard Edition (“JAVA SE”) platforms and environments. JMX can support any information model including CIM, in that JMX is information model agnostic, but it does not have meta-model support or any specific CIM related support built-in.

Current CIM to JMX mappings typically deal with numerous semantic choices of mapping in order to create a map more closely aligned to the Java world. These additional semantics make it difficult to extend the mapping technique to arbitrary CIM-derived models in a coherent and uniform manner. In addition, existing mappings of the CIM to JMX do not provide any support for meta-model schema management, since JMX itself does not provide such support. What is needed is a regular mapping to be able to convert from a CIM class description to a JMX MBean interface specification, and for support of the CIM meta-model such that it becomes possible to map a request on a CIM model or CIM meta-model to an equivalent request on a JMX MBean Server with CIM support.

### SUMMARY OF THE INVENTION

Briefly stated, the present invention involves computer implement methods and systems for mapping a common information model to the Java management extension model without prior knowledge of the CIM types that are available, and to provide support for the CIM meta-model schema within the context of the JMX MBean Server. A compiler converts managed object format code or common information model extensible markup language code to instances that can be implemented by management extension models such as JMX. The instances which are generated by the compiler interface work together with a meta-model service that exposes the semantics of each object within the common information model to the run-time environment through a parallel managed extension model (JMX) interface. This meta-model also introspects the common information model so as to provide a query and management service by forming associations between objects of the common information model and instances of the management extension model.

The present invention presents embodiments that expose common information derived models to the Java management extension model MBeans server so as to be accessible through both JMX and Web Services for System Management (WS-MAN) without specific additional code being developed by the individuals providing protocol adaptors. Furthermore, the mapping provides the capacity to aggregate other CIM derived models in a coherent manner without a-priori knowledge of the model(s) being aggregated.

The foregoing and other features, utilities and advantages of the invention will be apparent from the following more particular description of an embodiment of the invention as illustrated in the accompanying drawings.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 shows a computer operating system and its management components as known in the prior art;

FIG. 2 shows a flow diagram for one method embodiment of mapping a common information model to a management extension model according to the present invention; and

FIG. 3 shows a high level block diagram of initiation of a JMX query using a meta-model based CIM query according to one embodiment of the present invention.

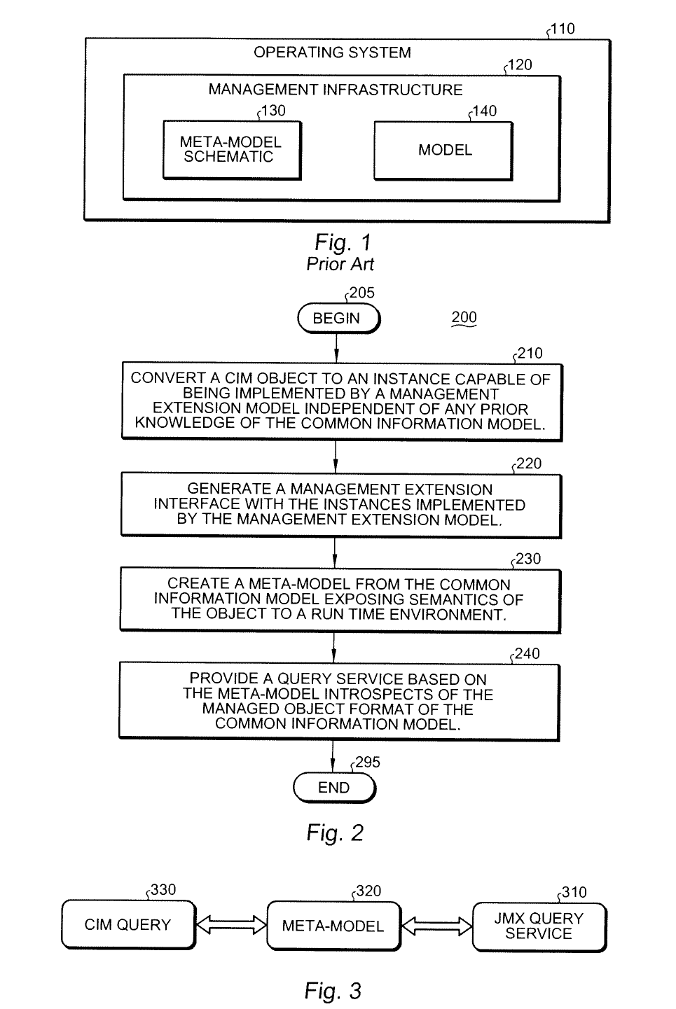

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The present invention for build-time and run-time mapping of the Common Information Model to Java Management Extension MBeans is hereafter described. JMX/MBeans allows for the detailed control and management over individual objects and groupings of objects in an application. To gain this control and according to various embodiments of the present invention, pertinent aspects of the CIM must be mapped to JMX.

According to one embodiment of the present invention, portions of the CIM, including model semantics, that are necessary to support a CIM view of an object in a system, are mapped to JMX for a Java view of the system while portions of the CIM viewed as too expensive or too ‘heavy’ to be supported in JMX or Java are ignored. The resulting mapping introduces a minimalist CIM map into JMX that precludes the introduction of CIM specific types unnecessary for the Java run-time. Necessary CIM specific types are transformed to Java specific types for use in the Java run-time. Simultaneously, the Java run-time maintains access to the sole CIM semantics of the CIM model though a parallel CIM-JMX model interface. This allows developers to program in Java without having to be concerned with CIM specific types or CIM semantics.

FIG. 2 shows a flow chart of a method 200 for mapping a common information model to a management extension model. The mapping of CIM to JMX, according to one embodiment of the present invention, begins 205 with converting 210 the CIM to an implementation technology. The CIM is normally represented in a language called MOF. While other language representations of the CIM are possible, MOF is widely accepted in the art for its ASCII representation of CIM. According to one aspect of the present invention, a compiler takes the MOF (or similar) representation of the CIM and generates 220 Java interfaces that can be then used to write Java code. It is common in the art to have compilers that take an abstract language and generate a specific implementation, however, the compiler of the present invention takes a specific implementation of CIM, in this case in the form of MOF, and converts it to a generic Java format. Previous mappings for such tooling with Java required a CIM Object Manager (CIM-OM) interface that was very much structured around CIM, CIM types, CIM classes and so forth. The result was a list of CIM derived Java classes which do not directly correlate to JMX. Some of the semantics from the CIM model are lost in the mapping to JMX MBean interfaces, this includes some of the typing information (e.g. unsigned CIM types are mapped to signed Java types, and CIM qualifier information is lost). No new types to support CIM are introduced. This lost information is preserved by the meta-model mapping as is described below.

The CIM is used at runtime to create 230 a meta-model exposing the semantics of the object types to the runtime environment. This meta-model is used at runtime to augment an Mbean's self-descriptive information to provide the full CIM semantics, and as a basis to respond to queries on the CIM meta-model query service. The present invention takes advantage of these interfaces and maps CIM to simple types in JMX. The resulting mapping is a light weight efficient representation of CIM in JMX that developers can use to write Java code. The light weight nature of the mapping discards some semantics of CIM such as unsigned CIM types. These types are not mapped into JMX according to the present invention. Instead of introducing a new Java type, the unsigned CIM type is mapped into an equivalent Java type that is native to Java and is signed. In doing this mapping, some semantics and qualifiers are lost, however, those that are lost are not required in the Java run-time. The loss of these qualifiers and semantics is a tradeoff to the ease associated with manipulating normal Java objects by programmers and developers.

This type of mapping assumes no a-priori knowledge of the CIM model when performing the mapping to JMX. In particular, there is no knowledge of the full set of CIM classes that may be included in a model and there is no knowledge of the semantics of the CIM model which may facilitate in the mapping of specific parts of the model to a more natural Java form. Prior CIM mappings to JMX had semantic knowledge of the model and provided specific mappings for certain pieces of the model (e.g. The introduction of CIM-specific types in the JMX interface, or the mapping of CIM's ‘datetime’ type sometimes to ‘java.util.Date’ and other times to ‘java.lang.Long’, based upon context, making it hard to provide a regular mapping in a programmatic manner.) It is one object of the present invention to correct this deficiency.

To accomplish this trade-off, both the CIM model and the CIM meta-model are mapped. Two namespaces are used. The first namespace is that of the CIM model, and contains MBean instances representing CIM class instances. Each MBean instance respects the MBean interface which is derived from the CIM class description for its type of CIM class. The MBean information for each MBean instance carries with it not only the Java MBean interface description, but also the information about the CIM class interface that this MBean implements. The second namespace is that of the CIM meta-model, and contains MBean instances representing CIM classes (not CIM class instances). Each MBean exposes the MBean interface to describe a CIM class, permitting the navigation inside the meta-model (obtaining all the data from the CIM model itself, such as parent and child classes, attributes, qualifiers, operations, parameters, etc). The JMX/MBean mapping thus provides for additional data associated with the JMX interface at the level of the meta-model.

Known as MBean information, this data carries information about the interface that is not part of the Java language representation. For example, structural data about the interface useful to a client creating a presentation is provided. In addition to the meta-model service information, qualifiers and other aspects of the CIM are added into the MBean allowing users access to all of the attributes of the CIM when desired. As such, the information about the CIM model maps into two areas in JMX—the per-MBean information about the MBean (MBean Information) and the meta-model information about the CIM class.

The mapping of the CIM-based modeling to a JMX-based modeling is accomplished in a generic manner, according to one embodiment of the present invention. As previously suggested, earlier mappings are specific in nature where the extent of the model and its limits are known. These limits are removed from the present mapping. Additionally, the JMX mappings of the present invention supports 230 a meta-model service regarding meta-data about the CIM classes. This data is available through a parallel namespace. Each CIM-derived managed object has, in one embodiment of the present invention, a name that defines a mapping to JMX names. There is a corresponding and parallel namespace for the meta-model for each of the CIM classes and CIM associations so as to be present and examinable using JMX protocols.

Another aspect of the present invention is the ability to map queries 240 across the JMX model. As JMX does not have a notion of class inheritance and class hierarchies, polymorphic queries according to class and subclasses are not possible. To do so requires the use of CIM meta-data. As previously discussed, CIM-OM has support for a meta-model via specific queries. Previous approaches presumed a well-known model with no need to support a meta-model at run-time. Therefore, according to one embodiment of the present invention and as shown in FIG. 3, a JMX query 310 is implemented using meta-data obtained from the CIM MOF file available at run-time. This allows class-based JMX queries 310 across the model. The polymorphic CIM query 330 is thus performed by introducing a new meta-model 320 query service, with its interface published as a JMX/MBean visible through JMX, and performing the query on the new MBean. The meta-model query service addresses the polymorphism by introspecting the meta-model and does non-polymorphic queries on CIM-derived MBeans using the JMX query service.

To better understand the present invention, the following descriptions of the mappings of different aspects of CIM to JMX are provided. In the following sections, aspects of the CIM such as classes, types, class instances, properties, qualifiers, methods, associations, object paths, etc. are presented along with their corresponding mapping to JMX to present descriptive examples of the present invention.

Recall that the basic definition of a unit of management is the class. A class is a named, structured data type, containing individual data item fields called properties. According to one embodiment of the present invention, CIM Classes are mapped into an equivalent Java MBean interface and CIM types are mapped to Java types. In the context of the present invention, a class is a template for a representation object for a set of devices that match the class definition.

While most classes are representation objects for real-world devices, there is no restriction on the content or the application of the class to a particular managed object. However, a particular CIM implementation may place limits on the number of properties in a class or the types of properties, or other similar limits. Once published, class definitions are immutable and universal, and thus changes are typically effected by either derivation from existing classes or creation of new classes. Note that because of the shared and distributed nature of classes, changing a class definition has the potential to impact managed entities that are currently deployed.

As in object-oriented paradigms, classes in the CIM can be derived from superclasses in a top-to-bottom fashion. In such a relationship, a derived class implicitly inherits or contains the entire contents of its superclass. For purposes of simplicity, the present CIM meta-model supports single inheritance only, although more complex inheritance models are feasible and contemplated by the present invention. As used herein, the terms base class and superclass may be used interchangeably to indicate a parent, while the terms derived class or subclass may be used to indicate a child class.

The fields of a class definition are called properties of the class, and are named values subject to naming guidelines. Further refinement of the semantics of property values is achieved through the use of what are called qualifiers. Qualifiers, therefore, are applied to properties to give additional semantics to properties which in turn give additional semantics to each class.

In a fundamental sense, a class defines a template for describing managed objects. Based on a class definition, specific managed objects are defined using instances of that class. Where the class models the real-world device or component in the general sense, each instance represents a specific occurrence of the class. For each CIM class named: <schema name>.<class name>CIM an MBean interface is generated with the name <information model prefix>.<schema name in lowercase>.<class name>MBean.

TABLE 1
Constants found in a CIM-derived MBean interface

| constant name | Type | Value |
|---|---|---|
| CIM_CREATIONCLASSNAME | String | <schema |
| | | name>.<class name> |
| | | in the original case as |
| | | specified |
| CIM_PROPERTY.<name> | String | A constant defining |
| | | the name of each CIM |
| | | Property |
| CIM_KEYS | String[ ] | CIM key properties in |
| | | order of definition |
| CIM_CLASSVERSION | String | version as defined in |
| | | CIM class |
| CIM_CLASSTYPE | String | one of: “CIMClass”, |
| | | “CIMIndication”, |
| | | “CIMAssociation” |

Hereafter, the information model prefix “com.sun.smim” will be used in the examples.

The generated Java MBean interface follows the same Java inheritance hierarchy as defined in the CIM inheritance hierarchy. These constants may include:

Below are some example mappings of CIM Class names:

TABLE 2
Example mappings of CIM Class names

| CIM | Java equivalent |
|---|---|
| CIM_ComputerSystem | com.sun.smim.cim.ComputerSystem |
| SUN_SolarisComputerSystem | com.sun.smim.sun.- |
| | SolarisComputerSystem |

CIM also defines both signed and unsigned integer types, plus several other types such as floats, references, characters, timestamps, and time intervals. CIM does not define the internal implementation of the NULL value other than it indicates that no value has been provided. According to one embodiment of the present invention, the NULL value is not explicitly supported. This lack of support provides a choice of using Java primitive types (e.g. int) rather than wrapped types (e.g. Integer).

In another aspect of the present invention, CIM types are mapped to Java types as exposed via an MBean interface. In accomplishing the mapping, two options are used. According to one embodiment of the present invention, wrapped types are used everywhere creating a new Java wrapper class for every CIM type not having a one-to-one correspondence to a Java type. This option possesses the advantage of preserving CIM semantics throughout the interface and automatically checking the type range. This approach however is not a JMX best practice and is a less natural Java standard.

The other option, according to one preferred embodiment, was to map the CIM type down to Java standard types wherever possible and to use open-data objects when this was not possible. The advantage of this approach is that it meets JMX best practice guidelines and provides a more natural Java paradigm. The only disadvantage is that this approach loses some of the CIM semantics and range checking in the typing.

Consistent with the second option of type CIM-JMX mapping, that is mapping CIM types down to standard Java and JMX types, the architecture to support both models exists so as to provide support for a new type of CIM/MBean that will have a strongly CIM-typed interface and that will automatically be mapped at run-time down to the standard Java and JMX types across the MBean interface.

A summary of the mapping of CIM types to JMX types is presented below.

TABLE 3
Map of CIM types to their Java equivalents

| CIM data | | | |
|---|---|---|---|
| type | Java data type | Comment | Java wrapped type |
| NULL | For method return | No need to support the | N/A |
| | values this maps to | NULL value explicitly, so | |
| | void. For properties, | no need for a wrapped type | |
| | this maps to an uninitialized | everywhere in order to be | |
| | value. | able to specify the NULL | |
| | | value. | |
| REF | javax.management. | See the mapping of CIM | javax.wbem.cim.CIMObjectPath1 |
| | ObjectName | Object Paths below | |
| UINT8 | short | CIM Unsigned types are | javax.wbem.cim.UnsignedInt8 |
| | | mapped to | |
| UINT16 | int | the standard Java signed | javax.wbem.cim.UnsignedInt16 |
| | | type big enough to contain | |
| UINT32 | long | the maximum | javax.wbem.cim.UnsignedInt32 |
| | | unsigned value, i.e. to the | |
| UINT64 | java.lang.BigInteger | next size | javax.wbem.cim.UnsignedInt64 |
| | | up. | |
| SINT8 | byte | CIM signed types have a 1—1 | java.lang.Byte |
| SINT16 | short | correspondence to Java | java.lang.Short |
| SINT32 | int | signed types of the same | java.lang.Integer |
| SINT64 | long | size. | java.lang.Long |
| STRING | java.lang.String | | java.lang.String |
| BOOLEAN | boolean | | java.lang.Boolean |
| REAL32 | float | | java.lang.Float |
| REAL64 | double | | java.lang.Double |
| CHAR16 | char | | java.lang.Character |
| DATETIME | java.lang.String | DATETIME contains a | javax.wbem.cim.CIMDateTime |
| | | String representation of | |
| | | either a timestamp | |
| | | (including timezone | |
| | | information) or an interval. | |

CIM properties are the equivalent to, and thus mapped to, MBean attributes. While CIM properties are by default read only, they may be altered to become both read and write capable through use of a specific qualifies (as described below). According to one embodiment of the present invention, each CIM property is mapped to a JMX/MBean attribute. Appropriate accessor and mutator methods consistent with this attribute are generated in the MBean interface.

A CIM method is mapped to a Java method. A CIM method is an operation combined with a signature. The signature consists of a list of parameters and a return type. The Java method that the CIM method is mapped in to possesses the same name with the first character changed to the lower case to comply with Java coding requirements. Method parameters and return values are correspondingly mapped to the equivalent Java data type.

According to one aspect of the present invention, a CIM qualifier of ‘Out’ that alters the method parameter results in the generation of an Open Data compatible helper object that contains both the return value and the Out Parameter. The Java method's return type is changed to be composite data accordingly. When a CIM qualifier of ‘In’ is recognized, the parameter is not included in the JMX mapping.

CIM object paths are simple URL-style links to objects (classes or instances). Object paths of this type normally take the form of a quoted string and is a combination of a namespace and the model path. Object paths identify an object or the performance of an action on the object. According to one aspect of the present invention, CIM object paths map to JMX ObjectNames. JMX/MBeans representing CIM instances in JMX have a unique object name of the pattern, <information model domain>: type=<class name>, [<key>=“<value>”]+ where, <information model domain> is defined by the meta-model and <class name> is the name of the CIM derived class including its schema. The list of key/value pairs after “type” contains all of the CIM keys for the instance with the values quoted using objectname.quote( ).

JMX/MBeans always have a unique ObjectName. It is possible that a CIM derived MBean may not be directly referred to with an object name in which the ‘type’ key is set to one of its superclasses. According to one embodiment of the present invention, when a client does not know the exact type of key to use for an action, a query to the CIM meta-model at run-time with a superclass can be accomplished to identify the appropriate object name to use for any subtypes.

With respect to CIM classes, and according to one embodiment of the present invention, JMX/MBeans have a unique object name following the pattern, <information meta-model domain>:type=CIMClass,name=<class name>, where, <information meta-model domain> is defined by the meta-model and <class name> is the name of the CIM class including its schema.

Qualifiers modify a CIM class definition, an instance, or a property. Qualifiers constitute meta-data, and are generally, though not necessarily, non-essential modifiers. As most qualifiers are nonessential, the removal of the qualifier does not substantially change the meaning of what is being modified. The presence and values of qualifiers may vary between CIM installations, even for the same class definitions but in general, if removal of a qualifier would seriously alter a class or instance definition, then that qualifier should be re-implemented as a property.

According to one embodiment of the present invention, qualifiers whose removal would seriously alter a class or instance are identified and their removal prevented so as to prevent the loss or alteration of any class data. In similar fashion, other CIM aspects are either removed or retained based on their impact to the class or instance definition. Each CIM qualifier added to MBean causes a descriptor field to be added to the appropriate element of the MBean information.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

While the invention has been particularly shown and described with reference to a preferred embodiment thereof, it will be understood by those skilled in the art that various other changes in the form and details may be made without departing from the spirit and scope of the invention.

A presently preferred embodiment of the present invention and many of its improvements have been described with a degree of particularity. It should be understood that this description has been made by way of example, and that the invention is defined by the scope of the following claims.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies and other aspects are not mandatory or significant, and the mechanisms that implement the invention or its features may have different names, divisions and/or formats. Furthermore, as will be apparent to one of ordinary skill in the relevant art, the modules, managers, functions, systems, engines, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with specific computer virtualization architecture, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A computer implemented method for mapping a common information model to a management extension model independent of prior knowledge of the common information model, the method comprising:
converting objects from the common information model to instances capable of being implemented by the management extension model, wherein each object of the common information model comprises a specification and a schema;
generating a management extension interface based on the instances implemented using a set of common information model objects supported by the management extension model; and
creating from the common information model, a meta-model service of the objects exposing information regarding the objects to a run-time environment through a parallel managed extension model interface.

2. The computer implemented method of claim 1, wherein generating comprises forming an interface between the common information model and the management extension model such that, when possible, common information model types are mapped to Java standard types, and responsive to common information model types not being able to be mapped to Java standard types, common information types being mapped to open-data objects.

3. The computer implemented method of claim 1, wherein generating comprises forming an interface between the common information model and the management extension model such that each common information model property is mapped to a management extension model attribute.

4. The computer implemented method of claim 1, wherein generating comprises forming an interface between the common information model and the management extension model such that each common information model method is mapped to a management extension model method of an identical name.

5. The computer implemented method of claim 4, wherein information lost in the mapping of each common information model method to the management extension model method is preserved by a meta-model mapping.

6. The computer implemented method of claim 1, wherein generating comprises forming an interface between the common information model and the management extension model such that <schema name>_<class name> for the common information model class is equivalent to <information model prefix>.<schema name>.<class name> for the equivalent management extension model.

7. The computer implemented method of claim 1, wherein the common information model is presented in a common information model extended markup language format.

8. The computer implemented method of claim 1, wherein the common information model is presented in a common information model managed object format.

9. The computer implemented method of claim 8, wherein the meta model service introspects the managed object format of the common information model to provide a query service producing associations between objects of the common information model and instances of the management extension model

10. The computer implemented method of claim 1, wherein generating comprises forming an interface between the common information model and the management extension model such that each common information model object path is mapped to a management extension model object name.

11. The computer implemented method of claim 1, wherein the meta-model service provides to the management extension model attribute information about the common information model.

12. The computer implemented method of claim 1, wherein the meta-model service provides to the management extension model parent and child information about the common information model.

13. The computer implemented method of claim 1, wherein the management extension model is a Java management extension model, and wherein the meta-model service exposes a managed object format of the common information model to the Java management extension model providing common information model-derived class information to the Java management extension model.

14. The computer implemented method of claim 13, further comprising matching a Java management extension based query to the common information model meta-model.

15. The computer implemented method of claim 13, wherein generating comprises correlating each construct of a managed object format version of the common information model to a corresponding construct of the Java management extension model making common information model data available for examination in run-time.

16. A computer system for mapping a first information model to a second information model independent of prior knowledge of the first information model, the computer system comprising:
a software portion configured to convert objects from the first information model to instances capable of being implemented by the second information model, wherein each of the objects comprise a specification and a schema;
a software portion configured to generate a second information model interface based on the instances using a set of first information model objects supported by the second information model; and
a software portion configured to create from the first information model, a meta-model service of the objects exposing information regarding the objects to a run-time environment through a parallel model interface of the second information model, wherein the meta-model service provides to the second information model parent and child information about the first information model.

17. A computer system for mapping a common information model to a management extension model independent of prior knowledge of the common information model, the system comprising:
a software portion configured to convert objects from the common information model to instances capable of being implemented by the management extension model, wherein each of the objects comprises a specification and a schema;
a software portion configured to generate a management extension interface based on the instances using a set of common information model objects supported by the management extension model; and
a software portion configured to create from the common information model, a meta-model service of the objects exposing information regarding the objects to a run-time environment through a parallel managed extension model interface, wherein the meta-model introspects the common information model to provide a query service producing associations between objects of the common information model and instances of the management extension model.

18. The computer system of claim 17, wherein the management extension model is a Java management extension model, and wherein the meta-model service exposes a managed object format of the common information model to the Java management extension model providing common information model-derived class information to the Java management extension model.

19. The computer system of claim 17, further comprising a software portion configured to match a Java management extension based query to the common information model meta-model.

20. The computer system of claim 17, wherein the software portion configured to generate comprises a software portion to correlate each construct of a managed object format version of the common information model to a corresponding construct of the Java management extension model making common information model data available for examination in run-time.
